(19) United States
(12) Patent Application Publication
(10) Pub. No.: US 2018/0205085 A1
(43) Pub. Date: Jul. 19, 2018

(54) SILICON-BASED COMPOSITE WITH THREE DIMENSIONAL BINDING NETWORK FOR LITHIUM ION BATTERIES

(71) Applicant: Robert Bosch GmbH, Stuttgart (DE)

(72) Inventors: Jun YANG, Shanghai (CN); Yitian BIE, Shanghai (CN); Jingjun ZHANG, Shanghai (CN); Yuqian DOU, Shanghai (CN)

(21) Appl. No.: 15/742,626

(22) PCT Filed: Jul. 7, 2015
(86) PCT No.: PCT/CN2015/083487

§ 371 Date: Jan. 8, 2018

(51) Int. Cl. H01M 4/62; H01M 4/04; H01M 4/134; H01M 4/1395; H01M 4/38; H01M 10/0525

(52) U.S. Cl. CPC H01M 4/622; H01M 4/04; H01M 10/0525; H01M 4/1395; H01M 4/386; H01M 4/134

(57) ABSTRACT

The present invention relates to a silicon-based composite with three dimensional binding network and enhanced interaction between binder and silicon-based material, which comprises silicon-based material, treatment material, a binder containing carboxyl groups and conductive carbon, wherein the treatment material is selected from the group consisting of polydopamine or silane coupling agent with amine and/or imine groups; as well as relates to an electrode material and a lithium-ion battery comprising said silicon-based composite, and a process for preparing said silicon-based composite.

### TECHNICAL FIELD

The present invention relates to a silicon-based composite with three dimensional binding network and enhanced interaction between binder and silicon-based material for lithium ion batteries; as well as an electrode material and a lithium ion battery comprising said silicon-based composite.

### BACKGROUND ART

With the rapid development and popularization of portable electronic devices and electronic vehicles, the demand for lithium ion batteries with increased energy and powder density becomes more and more urgent. Silicon is a promising alternative electrode material for lithium ion batteries owning to its large theoretical capacity (Li₁₅Si₄, 3579 mAh g⁻¹) and moderate operating voltage (0.4 V vs Li/Li⁺).

However, there are many challenges for the practical application of silicon, for example, during lithiation/dilithiation process, silicon undergoes dramatic expansion and contraction, which would cause ninny cracks in both Si-based active materials and electrode. These cracks lead to loss of electronic conductivity. In addition, the cracks also results in continuous growth of solid-electrolyte interphase (SEI), which results in loss of ionic conductivity and consumption of Li, and thus leads to fast capacity decay. Great efforts have been paid in designing Si-based materials with nano or porous structure to mitigate the negative volume effect and improve the electrochemical performance.

Beyond the active materials, recent studies have shown that the binder network also plays a critical role in maintaining the electrode integrity during volume change in the electrode and is associated with many important electrochemical properties, especially the cycling performance.

Among all kinds of binders, binders comprising carboxyl groups, such as polyacrylic acid (PAA), carboxymethyl cellulose (CMC), sodium alginate (SA) are more used since the carboxyl groups on the binders can form hydrogen bonds with silicon. Nevertheless, the hydrogen bonds formed by carboxyl groups are still not strong enough to endure the extent volume change of silicon, especially in high mass loading situation. Besides, the binding network formed by above linear binder is also not strong enough to maintain the electrode integrity during long cyling. There are needs to make further modification to ameliorate the binder.

### SUMMARY OF INVENTION

It is therefore an object of the present invention to provide further modification to the binder used in a silicon-based composite for lithium ion batteries. According to the present invention, three dimensional binding network and enhanced interaction between binder and silicon-based material can be established in the silicon-based composite by further incorporating treatment material into the composite, wherein said treatment material can be selected from the group consisting of polydopamine (briefed as “PD” hereinafter) and silane coupling agent with amine and/or imine groups.

According to the present invention, an enhanced interaction between a binder and silicon-based material can be realized by either stronger hydrogen bonds formed between catechol groups in PD and Si—OH, or covalent bonds formed between the hydrolysis ends in the silane coupling agent and Si—OH. Moreover, PD or silane coupling agent with amine and/or imine groups is linked to the binder through covalent bond formed by amine/imine group in PD or in silane coupling agent with the carboxyl group contained in the binder.

Accordingly, the present invention provides a silicon-based composite with three dimensional binding network and enhanced interaction between binder and silicon-based material for lithium ion batteries, said composite comprises silicon-based material, treatment material, a binder which contains carboxyl groups, and conductive carbon, wherein the treatment material is selected from the group consisting of polydopamine (PD) and silane coupling agent with amine and/or imine groups.

The present invention further provides an electrode material, which comprises the silicon-based composite according to the present invention.

The present invention further provides a lithium ion battery, which comprises the silicon-based composite according to the present invention.

According to the present invention, a process for preparing the above silicon-based composite, wherein the treatment material is PD, is provided, which comprises the steps of dispersing silicon-based material in a buffer solution containing dopamine, initiating in-situ polymerization of dopamine on the surface of the silicon-based material by air oxidization, collecting the silicon-based material coated by polydopantine, and crosslinking the polydopamine to a binder which contains carboxyl groups.

Alternatively, according to the present invention, a process for preparing the above silicon-based composite, wherein the treatment material is silane coupling agent with amine and/or imine groups, is provided, which comprises the steps of adding silane coupling agent with amine and/or imine groups into a slurry comprising silicon-based material, a binder which contains carboxyl groups and conductive carbon during stirring.

### BRIEF DESCRIPTION OF DRAWINGS

FIG. 1 is a schematic illustration of the three dimensional binding network and the corresponding structural formula when polydopamine is added to the silicon-based composite.

FIG. 2 is Transmission Electron Microscopy (TEM) images showing (a) pristine Si particles, (b) Si@PD particles prepared in Example 1 and (c) in Comparative Examples 1b.

FIG. 3 is a schematic illustration of the three dimensional binding network and the corresponding structural formula when silane coupling agent with amine and/or imine groups is added to the silicon-based composite.

FIG. 4 is Fourier transform infrared (FT-IR) spectra of (a) Si electrode prepared with addition of 1 wt % silane coupling agent KH550 obtained in Example 6, (b) pristine Si, and (c) PAA binder.

FIG. 5 is a plot showing the cycling performance of (a) the Si electrodes prepared in Example 1, (b) Comparative Example 1a and (c) 1 b with a low mass loading of active materials.

FIG. 6 is a plot showing the cycling performance of (a) the Si electrodes prepared in Example 2 and (b) Comparative Example 2 with a high mass loading of active materials.

FIG. 7 is a plot showing the cycling performance of the Si electrodes prepared in Comparative Example 1a, modified Si electrode prepared in Examples 3-6 and Comparative Example 3, with a low mass loading of active materials.

FIG. 8 is a plot showing the cycling performance of (a) the modified Si electrode prepared in Example 7 and (b) Comparative Example 2, with a high mass loading of active materials.

FIG. 9 is a plot showing the cycling performance of the Si electrodes prepared in Examples 4-6 and Comparative Example 4.

### DETAILED DESCRIPTION OF PREFERRED EMBODIMENTS

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

According to the present invention, three dimensional binding network can be established in the silicon-based composite used in lithium ion batteries by incorporating treatment material into the composite, wherein the treatment material is selected from the group consisting of polydopamine (PD) and silane coupling agent with amine and/or imine groups.

In the context of the present invention, said silicon-based material can be any suitable forms of silicon-based material as long as its surface could carry hydroxyl group, and the examples thereof can be silicon particles, silicon films and so on. For example, nano-silicon particles are used in the examples of the present invention.

In the context of the present invention, the binder which contains carboxyl groups can be any suitable binder as long as it carries carboxyl groups. The preferable binder is selected from the group consisting of polyacrylic acid (hereinafter briefed as “PAA”), carboxymethyl cellulose (hereinafter briefed as “CMC”), sodium alginate (hereinafter briefed as “SA”), copolymers thereof and combinations thereof.

In the context of the present invention, the silane coupling agent with amine and/or imine groups can be any suitable silane coupling agent as long as it carries amine groups, or imine groups, or both amine and imine groups.

In the context of the present invention, the abbreviated expression “Si@PD” is used to indicate the Si-based material coated by PD, which can be clearly understood by a person skilled in the art.

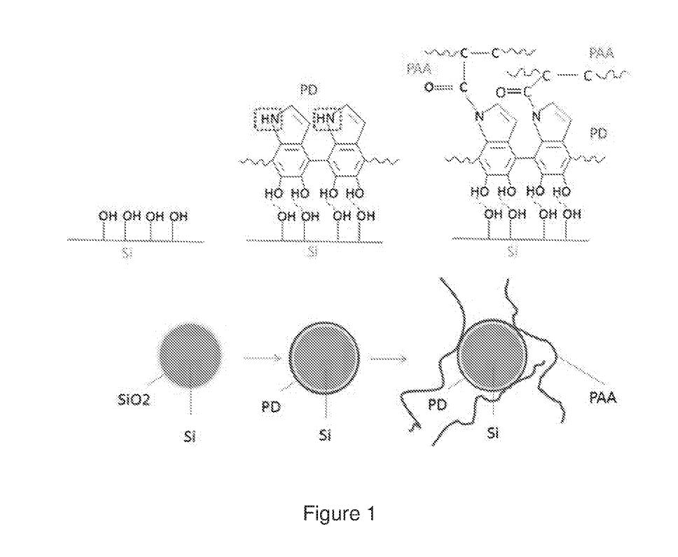

FIG. 1 shows a schematic illustration of the three dimensional binding network after PD is added to the silicon-based composite. As can be seen from FIG. 1, the silicon-based material is nano silicon particles that are covered with a thin layer of SiO₂ generated by air oxidation. If without PD coating, the interaction between silicon and binder (herein PAA) is by hydrogen bonds formed by carboxyl group in binder and Si—OH on Si surface. With PD coating, the interaction is changed to hydrogen bonds formed by catechol groups on PD and Si—OH on the surface of Si particles. These hydrogen bonds are stronger than previous hydrogen bonds formed between carboxyl group in PAA and Si—OH. Then, the imine groups of PD react with carboxyl groups of the binder, for example PAA, by condensation reaction, thus forming a three dimensional binding network.

In one embodiment of the present invention, a silicon-based composite with three dimensional binding network comprises silicon-based material, polydopamine coating on said silicon-base material, a binder which contains carboxyl groups, and conductive carbon. In a preferable embodiment of the present invention, the average thickness of the polydopamine coating layer on said silicon-based material is in the range of 0.5 to 2.5 nm, preferably 1 to 2 nm. Within the above range, the content of PD corresponds to about 5-8 wt is based on the weight of Si-based material.

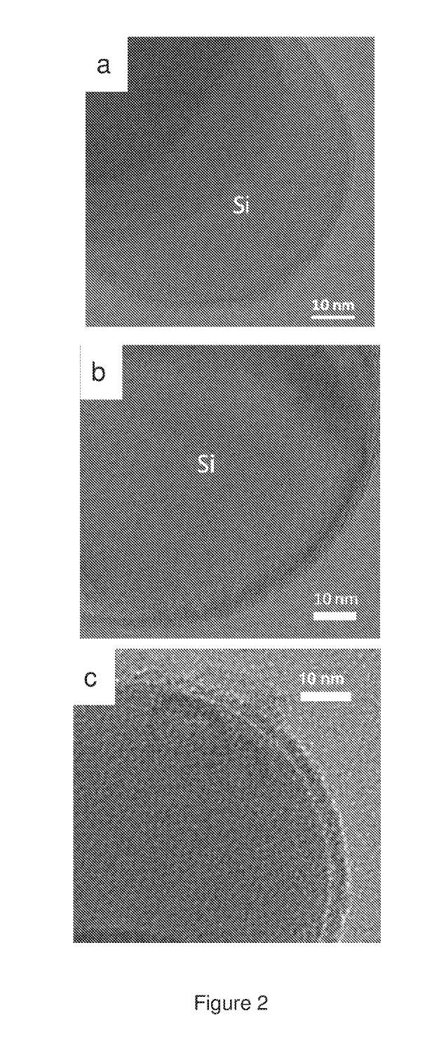

FIG. 2 is Transmission Electron Microscopy (TEM) images of pristine Si particles and Si@RD particles. In FIG. 2a, there is a thin layer of SiO₂ (ca. 3 nm) on the surface of pristine nano Si. After PD coating, the outer layer thickness increases to ca. 5 nm as shown in FIG. 2b, which indicates that the particles of silicon are uniformly coated with a layer of PD with thickness about 1-2 nm. FIG. 2c corresponds to Comparative Example 1b, wherein the thickness of a layer of PD is about 3 nm.

The preparation process for the above silicon-based composite with three dimensional binding network comprises: (1) dispersing silicon-based material in a buffer solution containing dopamine, (2) initiating in-situ polymerization of dopamine on the surface of the silicon-based material by air oxidization, (3) collecting the silicon-based material coated by polydopamine, and (4) crosslinking the polydopamine to a binder which contains carboxyl groups.

Alternatively, the present invention provides a silicon-based composite with three dimensional binding network, and said composite comprises silicon-based material, silane coupling agent with amine and/or imine groups, a binder containing carboxyl groups, and conductive carbon. In a preferable embodiment of the present invention, the amount of the silane coupling agent is from 0.01-2.5 wt %, preferably 0.05-2.0 wt %, more preferably 0.1-2.0 wt %, and much more preferably 0.1-1.0% based on the weight of the silicon-based material.

In an embodiment of the present invention, the examples of silane coupling agent with amine and/or imine groups can be suitable silane coupling agent that carries amine groups, or imine groups, or both amine and imine groups, and the preferable examples thereof are one or more selected from the group consisting of γ-aminopropyl methyl diethoxy silane (NH₂C₃H₆CH₃Si(OC₂H₅)₂), γ-aminopropyl methyl dimethoxy silane (NH₂C₃H₆CH₃Si(OCH₃)₂), γ-aminopropyl triethoxy silane (NH₂C₃H₆Si(OC₂₋₃)₃γ-aminopropyl trimethoxy silane (NH₂C₃H₆Si(OCH₃)₃), N-(β-aminoethyl)-γ-aminopropyl trimethoxy silane (NH₂C₂H₄NHC₃H₆Si(OCH₃)₃), N-(β-aminoethyl)-γ-aminopropyl triethoxy silane (NH₂C₂H₄NHC₃H₆Si(OC₂H₅)₃, N-(β-aminoethyl)-γ-aminopropyl methyl dimethoxysilane (NH₂C₂H₄NHC₃H₆SiCH₃(OCH₃)₂), N,N-(aminopropyltriethoxy) silane (HN[(CH₂)₃Si(OC₂H₅)₃]₂), γ-trimethoxysilyl propyl diethylenetriamine (NH₂C₂H₄NHC₂H₄NHC₃H₆Si(OCH₃)₃), γ-divinyltriamine propymethyldimethoxyl silane (NH₂C₂H₄NHC₂H₄NHC₃H₆CH₃Si(OCH₃)₂), bis-γ-trimethoxysilypropyl amine, aminoneohexyltromethoxysilane, and aminoneohexylmethydimethoxysilane.

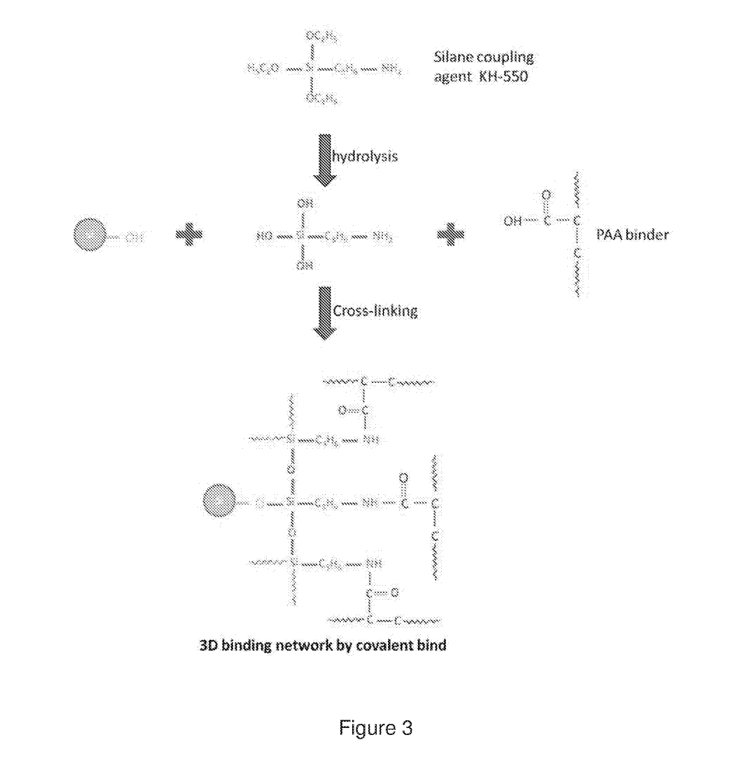

FIG. 3 is a schematic illustration of the three dimensional binding network after silane coupling agent with amine and/or imine groups is added to the silicon-based composite. The exemplified silane coupling agent KH550 contains three hydrolytic ends (—OC₂H₅) and one none-hydrolytic end (—C₃H₆—NH₂). During slurry preparation and further vacuum drying, the hydrolytic ends of silane coupling agent hydrolyze to form covalent bonds with Si—OH on silicon surface or hydrolytic ends of other silane coupling agent; on the other hand, the —NH₂ group in silane coupling agent react with —COOH group in the binder which contains carboxyl group; thus forming a strong three-dimensional binding network.

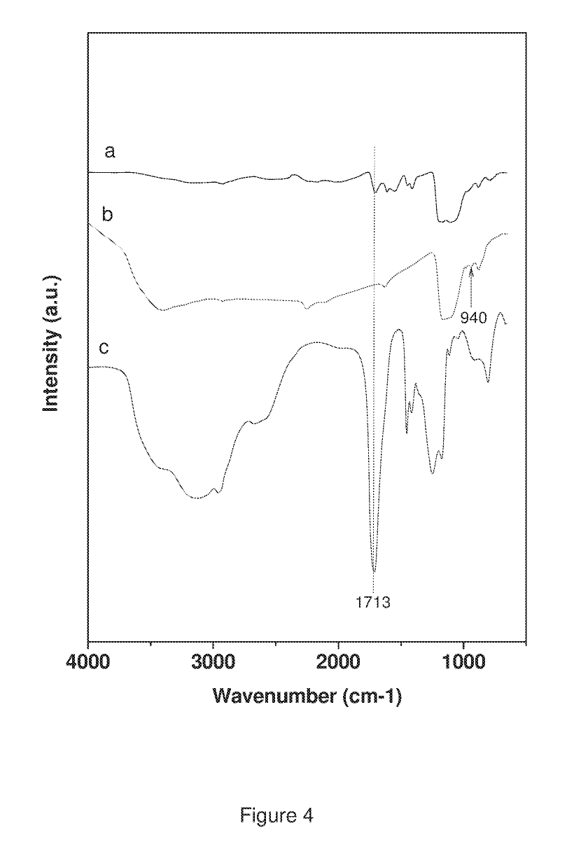

FT-IR spectra in FIG. 4 show the evidence of formation of three-dimensional network connected by covalent bonds. The peak at 940 cm⁻¹ in nano Si particles is attributed to vibration of silanol O—H group on the surface of nano Si. This peak almost disappears on Si electrode. This is due to the condensation of silanol groups on surface of Si with hydrolytic ends of KH550. The peaks at 1713 cm⁻¹ in PAA, which corresponds to stretching vibration of C═O in carboxyl group, blue shifts to 1700 cm⁻¹ in Si electrode due to the formation of amide. This result provides a proof of cross-linking reaction between —COOH in PAA binder and —NH₂ group in KH550.

The preparation process for the above silicon-based composite with three dimensional binding network comprises: adding silane coupling agent with amine and/or imine groups into a slurry comprising silicon-based material, a binder which contains carboxyl groups and conductive carbon during stirring.

Accordingly, the present invention provides a silicon-based composite comprising three dimensional binding network for lithium ion batteries.

The present invention further relates to an electrode material, which comprises the silicon-based composite according to the present invention.

The present invention further relates to a lithium-ion battery, which comprises the silicon-based composite according to the present invention.

### EXAMPLES

The following non-limiting examples describe preparation of the electrode comprising Si-based composite according to the present invention and compare the performance of the obtained electrodes with those prepared not according to the present invention. The following Examples illustrate various features and characteristics of the present invention, whose scope however is not to be construed as limited thereto:

### Example 1—Preparation of Electrode Comprising Si-Based Composite According to the Present Invention

### Preparation of Si-Based Composite and the Electrode

Firstly, 0.08 g nano silicon particles (50-200 nm) (Alfa-Aesar) were dispersed in 80 ml Tris-HCl (10 mM, pH=8.5) buffer solution containing 0.08 g dopamine hydrochloride (Alfa-Aesar) and then stirred for 2 h, during which period, dopamine is polymerized in situ on the surface of the silicon-based material by air oxidization. Then silicon particles coated by polydopamine were collected by centrifugation and washed by water and vacuum dried for future use. The thickness of PD coating was 1-2 nm according to TEM images. Then the particles prepared above were mixed with Super P (40 nm, Timical) and PAA (Mv ˜450 000, Aldrich) in an 8:1:1 weight ratio in water. After stirred for 5 h, during which period, the polydopamine is crosslinked to PAA, the slurry was coated onto a Cu foil current then further dried at 70° C. in vacuum for 8 h. The loading of active material is ca. 0.5 mg/cm². The foil was cut to Φ12 mm sheets to assemble cells.

### Comparative Example 1a

Comparative Example 1a was prepared similar to Example 1, except that pristine nano Si particles were used to prepare the electrode.

### Comparative Example 1b

Comparative Example 1b was prepared similar to Example 1, except that the nano silicon particles was changed to 0.4 g, dopamine hydrochloride was changed to 0.2 g, and Tris-HCl buffer solution was changed to 100 ml respectively. The stirring lasted for 6 h. The thickness of PD coating was about 3 nm according to TEM images. Then the particles prepared above were used to prepared electrode similar to Example 1.

### Example 2—Preparation of Electrode Comprising Si-Based Composite According to the Present Invention

Except that the loading of active material in electrode was changed from 0.5 mg/cm² to ca. 2.0 mg/cm², Example 2 was prepared similar to Example 1.

### Comparative Example 2

Comparative Example 2 was prepared similar to Comparative Example 1a, except that the loading of active material in electrode was changed from 0.5 mg/cm⁻ to ca. 2.0 mg/cm⁻.

### Cells Assembling and Electrochemical Test

The electrochemical performances of the above prepared electrodes were respectively tested using two-electrode coin-type cells. The CR2016 coin cells were assembled in an argon-filled glove box (MB-10 compact, MBraun) using 1 M (1:1 by volume, ethylene carbonate (EC), dimethyl carbonate (DMC)) as electrolyte, including 10% Fluoroethylene carbonate (FEC), ENTEK ET20-26 as separator, and pure lithium foil as counter electrode. The cycling performances were evaluated on a LAND battery test system (Wuhan Kingnuo Electronics Co., Ltd., China) at 25*C constant current densities. The cut-off voltage was 0.01 V versus Li/Li⁺ for discharge (Li insertion) and 1.2 V versus Li/Li⁺ for charge (Li extraction). The specific capacity was calculated on the basis of the weight of active materials.

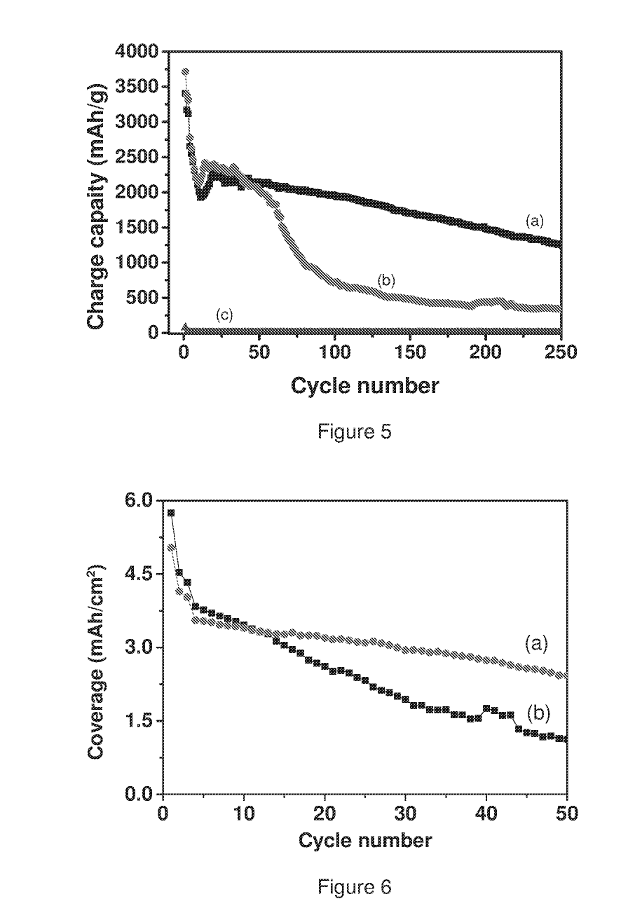

FIG. 5 shows the cycling performance of the cross-linked electrodes (Si@PD+PAA) in Example 1 and in Comparative Example 1b and conventional electrode (Si+PAA) in Comparative Example 1a with a low mass loading. The coin cell was discharged at 0.1 Ag⁻¹ for the first cycle and 0.3 Ag⁻¹ in the next two cycles and 1.5 Ag⁻¹ for the following cycles between 0.01 and 1.2 V vs Li/Li⁺. The mass loading of active materials (Si and Si@PD) in every electrode is ca. 0.5 mg/cm².

From FIG. 5, it can be seen that the cross-linked electrode in Example 1 (curve (a)) shows much better cycle performance than conventional electrode with only PAA binder (curve (b)). At a high current density of 1.5 Ag⁻¹, the conventional electrode with PAA binder shows fast capacity decay after 50 cycles and only 549 mAh/g capacity is remained after 150 cycles. While cross-linked electrode achieves specific capacity of 2128 and 1715 mAh g⁻¹ after 100 and 150 cycles, respectively. This improvement could be attributed to the three-dimensional binding network and enhanced interaction by stronger hydrogen bond. However, because of low electronic conductivity of PD, if the PD coating layer is too thick, for example 3 nm in Comparative Example 1b, the PD layer will inhibit the electron transfer. Therefore, Comparative Example 1b shows quite low capacity (curve (c)).

FIG. 6 further shows the cycling performance of the cross-linked electrode (Si@PD+PAA) in Example 2 and conventional electrode (Si+PAA) in Comparative Example 2 with high mass loading. The coin cell was discharged at 0.1 Ag⁻¹ for the first cycle and 0.3 Ag⁻¹ in the next two cycles and 0.5 Ag⁻¹ for the following cycles between 0.01 and 1.2 V vs Li/Li⁺. The mass loading of active materials (Si and Si@PD) in every electrode is ca. 2.0 mg/cm².

From FIG. 6, comparing with conventional electrodes with PAA as binders, the cross-linked electrode still gets obvious advantages with such high active material loading (2.0 mg/cm²). After 50 cycles, the specific capacity of cross-linked electrode is 1254 mAh g⁻¹ corresponding to 2.4 mAh/cm², while the conventional electrode only remains 1.1 mAh/cm².

The present invention has greatly improved electrochemical performances, especially cycle performance via wrapping the silicon particles with PD before making the electrode.

### Examples 3 to 7—Preparation of Electrodes Comprising Si-Based Composite According to the Present Invention

### Example 3

Firstly, 0.24 g nano silicon particles (Alfa Aesar, 50-200 nm) were mixed with 0.03 g Super P (40 nm, Timical) and 0.03 g PAA (Mv ˜450 000, Aldrich) in an 8:1:1 weight ratio in water. After stirred for 1 h, 0.024 mg (0.01% based on the weight of nano silicon particles) of silane coupling agent γ-aminopropyl triethoxysilane (KH550) was added into the slurry. After stirring for another 4 h, the slurry was coated onto a Cu foil current then further dried at 70° C. in vacuum for 8 h. The loading of active material is ca. 0.5 mg/cm². The foil was cut to Φ12 mm sheets to assemble cells.

Example 4 was prepared similar to Example 3, except that 0.24 mg KH1550 was added into slurry, corresponding to 0.1 wt % ratio of KH550 to Si.

Example 5 was prepared similar to Example 3, except that 1.2 mg KH550 was added into slurry, corresponding to 0.5 wt % ratio of KH550 to Si.

Example 6 was prepared similar to example 3, except that 2.4 mg KH550 was added into slurry, corresponding to 1 wt % ratio of KH550 to Si.

Example 7 was prepared similar to Example 4, except that the loading of active material in electrode is ca. 2.0 mg/cm².

### Comparative Examples 3 and 4—Preparation of Electrode Comprising Si-Based Composite not According to the Present Invention

Comparative Example 3 was prepared similar to Example 3, except that 7.2 mg KH550 was added into slurry, corresponding to 3 wt % ratio of KH550 to Si. An excess amount of KH550 would impair the electronic conductivity and deteriorate the cell performance.

### Comparative Example 4

The process used in Comparative Example 4 is different from the inventive process.

In Comparative Example 4, the process comprises firstly coating Si by silane coupling agent and then preparing the slurry. In contrast, the inventive process comprises directly adding silane coupling agent during the slurry preparation.

Specifically, in Comparative Example 4, 0.5 g nano silicon particles (50-200 nm) (Alfa-Aesar) and 0.005 g (corresponding to 1 wt %) silane coupling agent KH550 were firstly dispersed in 25 ml water and then stirred for 611. Then silicon particles coated by silane coupling agent were collected by centrifugation and washed by water for future use. Then the KH550 modified nano Si particles were used to prepared electrode similar to Example 3.

### Cells Assembling and Electrochemical Test

The electrochemical performances of the as-prepared anodes were tested using two-electrode coin-type cells. The CR2016 coin cells were assembled in an argon-filled glove box (MB-10 compact, MBraun) using 1 M LiPF₆/EC+DMC (1:1 by volume, ethylene carbonate (EC), dimethyl carbonate (DMC)) as electrolyte, including 10% Fluoroethylene carbonate (FEC), ENTEK ET20-26 as separator, and pure lithium foil as counter electrode. The cycling performances were evaluated on a LAND battery test system (Wuhan Kingnuo Electronics Co., Ltd., China) at 25° C. constant current densities. The cut-off voltage was 0.01 V versus Li/Li⁺ for discharge (Li insertion) and 1.2 V versus Li/Li⁺ for charge (Li extraction). The specific capacity was calculated on the basis of the weight of active materials.

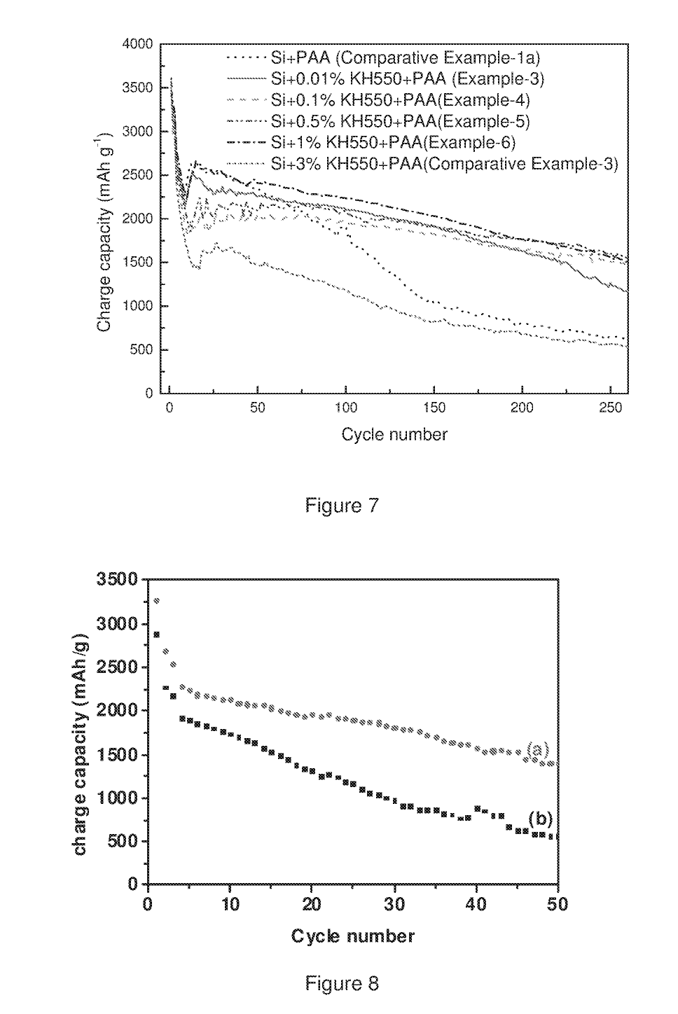

FIG. 7 is a plot showing the cycling performance of the Si electrodes without KH550 (Si−PAA) prepared in Comparative Example 1a and modified Si electrode (Si-KH550-PAA) prepared in Examples 3-6 and Comparative Example 3 with a low mass loading. The coin cell was charge/discharged at 0.1 Ag⁻¹ for the first cycle and 0.3 Ag⁻¹ in the next two cycles and 1.5 Ag⁻¹ for the following cycles between 0.01 and 1.2 V vs Li/Li⁺. The mass loading of active materials (Si) in every electrode is ca. 0.5 mg/cm⁻.

As shown in FIG. 7, the modified electrodes Si-KH550-PAA (with 0.01 wt %, 0.1 wt %, 0.5 wt % and 1 wt % of KH550) show much better cycling performance than both Si electrode without KH550 in Comparative Example 1a and the modified electrode Si-KH550-PAA having a high amount of KH550 (with 3.0 wt % KH550) in Comparative Example 3. And even at such a high current density (1.5 Ag⁻¹), the modified electrodes Si-KH550-PAA (with 0.01 wt %, 0.1 wt %, 0.5 wt % and 1 wt % of KH550) achieve specific capacity of more than 1690 mAh g⁻¹ after 180 cycles, while the capacity of Si−PAA reduces to less than 900 mAh g⁻¹ and the capacity of Si-KH550-PAA (with 3.0 wt % KH550) reduces to less than 750 mAh g⁻¹ under the same conditions. This improvement can be attributed to the formed strong three-dimensional binding network.

FIG. 8 shows the cycling performance of the modified Si electrode (Si-KH550-PAA) in Example 7 and Si electrode without KH550 (Si−PAA) in Comparative Example 1a with high loading. The coin cell was charge/discharged at 0.1 Ag⁻¹ for the first cycle and 0.3 Ag⁻¹ in the next two cycles and 0.5 Ag⁻¹ for the following cycles between 0.01 and 1.2 V vs Li/Li⁺. The mass loading of active materials (Si) in every electrode is ca. 2.0 mg/cm².

Since the high loading is meaningful for the commercial demand of high energy density, the effects of the present invention in high loading electrodes were investigated. As shown in FIG. 8, comparing with Si−PAA, the modified electrodes Si-KH550-PAA gets obvious advantages with such high active material loading (2.0 mg/cm²). Si-KH550-PAA shows higher capacity (3276 mAh/g, corresponding to 6.6 mAh/cm²) than Si−PAA (2886 mAh/g corresponding to 5.7 mAh/cm²). After 50 cycles, the Si-KH550-PAA remains 61% capacity, while the capacity of Si−PAA reduces to 29%.

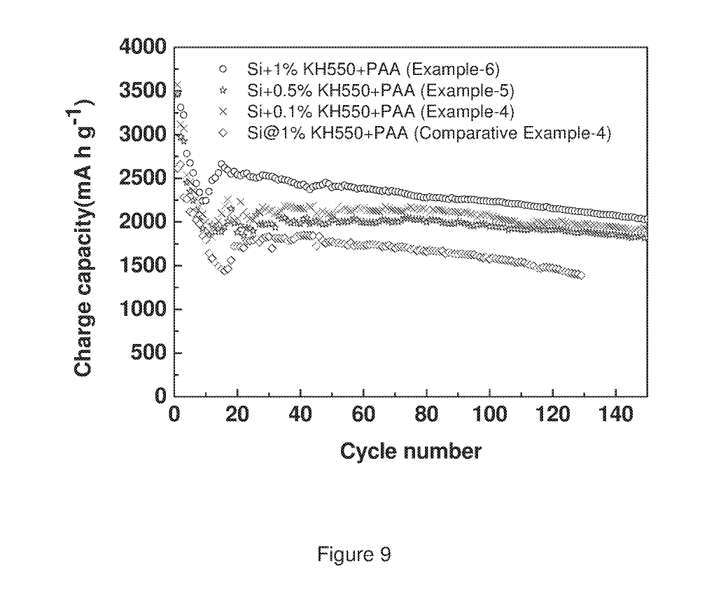

FIG. 9 is a plot showing the cycling performance of the Si electrode prepared in Example 4-6 and Comparative Example 4. In other words, FIG. 9 compared the electrochemical performance of electrodes prepared from two methods: 1) the method of the present invention, that is, directly adding KH550 during slurry preparation; 2) the method in Comparative Example 4, that is, pre-treating Si with KH550 and then using the KH550 modified Si to prepare slurry. The results show that the electrodes from directly adding KH550 have better cycling performance, especially after 40 cycles. After 100 cycles, the capacity of electrodes from the inventive method 1) remains ca. 2000 mAh/g, while the electrode from method 2) decrease to 1576 mAh/g.

Not binding to the theory, it is believed that directly adding KH550 during slurry preparation, the hydrolysis ends of one KH 550 molecule, in addition to connecting to the Si surface, also connect to hydrolysis ends of other KH550 molecule (KH550-KH550), after non-hydrolysis ends connect to PAA, highly cross-linked 31) binding network is formed. (PAA-KH550-KH550-PAA). Therefore, the binding network is more stable. While by pre-treat Si by KH550, such KH550-KH550 small molecules are removed during washing, thus generate less cross-linked point afterwards. Therefore, the cycling performance becomes poorer.

Therefore, the present invention has greatly improved electrochemical performances, especially cycle performance by forming covalent bond connected three dimensional binding network via adding silane coupling agent into the slurry during stirring.

1. A silicon-based composite with a three dimensional binding network and enhanced interaction between a binder and a silicon-based material, which comprises the silicon-based material, a treatment material, the binder which contains carboxyl groups, and conductive carbon, wherein the treatment material is selected from the group consisting of polydopamine and a silane coupling agent with amine and/or imine groups.

2. The silicon-based composite according to claim 1, wherein the treatment material is polydopamine, and the average thickness of a polydopamine coating on said silicon-based material is in the range from 0.5 to 2.5 nm.

3. The silicon-based composite according to claim 1, wherein the treatment material is silane coupling agent with amine and/or imine groups, and the amount of the silane coupling agent is from 0.01-2.5 wt %, based on the weight of the silicon-based material.

4. The silicon-based composite according to claim 1, wherein the binder is selected from the group consisting of polyacrylic acid, carboxymethyl cellulose, sodium alginate, copolymers thereof and combinations thereof.

5. The silicon-based composite according to claim 1, wherein the silane coupling agent is one or more selected from the group consisting of γ-aminopropyl methyl diethoxysilane, γ-aminopropyl methyl dimethoxy silane, γ-aminopropyl triethoxysilane, γ-aminopropyl trimethoxysilane, N-(β-aminoethyl)-γ-aminopropyl trimethoxy silane, N-(β-aminoethyl)-γ-aminopropyl triethoxy silane, N-(β-aminoethyl)-γ-aminopropyl methyl dimethoxysilane, N,N-(aminopropyltriethoxy) silane, γ-trimethoxysilyl propyl diethylenetriamine, γ-divinyltriamine propymethyldimethoxyl silane, bis-γ-trimethoxysitypropyl amine, aminoneohexyltrotnethoxysilane, and aminoneohexylmethydimethoxysilane.

6. An electrode material, comprising the silicon-based composite of claim 1.

7. A lithium-ion battery, comprising the silicon-based composite of claim 1.

8. A process for preparing the silicon-based composite of claim 1, comprising the steps of:
(1) dispersing the silicon-based material in a buffer solution containing dopamine,
(2) initiating in-situ polymerization of dopamine on a surface of the silicon-based material by air oxidization,
(3) collecting the silicon-based material coated by polydopamine, and
(4) crosslinking the polydopamine to the binder which contains carboxyl groups.

9. A process for preparing the silicon-based composite of claim 1, comprising adding the silane coupling agent with amine and/or imine groups into a slurry including the silicon-based material, the binder which contains carboxyl groups and the conductive carbon during stirring.

10. The silicon-based composite according to claim 1, wherein the treatment material is polydopamine, and the average thickness of a polydopamine coating on said silicon-based material is in the range from 1 to 2 nm.

11. The silicon-based composite according to claim 1, wherein the treatment material is silane coupling agent with amine and/or imine groups, and the amount of the same coupling agent is from 0.05-2.0 wt %, based on the weight of the silicon-based material.

12. The silicon-based composite according to claim 1, wherein the treatment material is silane coupling agent with amine and/or imine groups, and the amount of the silane coupling agent is from 0.1-2.0 wt %, based on the weight of the silicon-based material.

13. The silicon-based composite according to claim 1, wherein the treatment material is silane coupling agent with amine and/or imine groups, and the amount of the silane coupling agent is from 0.1-1.0%, based on the weight of the silicon-based material.
